(19) United States
(12) Patent Application Publication
(10) Pub. No.: US 2025/0189621 A1
(43) Pub. Date: Jun. 12, 2025

(54) PHASE NOISE REMOVAL

(71) Applicant: NXP B.V., Eindhoven (NL)

(72) Inventors: Massimo Ciacci, Den Bosch (NL); Nikita Petrov, Helmond (NL)

(21) Appl. No.: 18/961,836

(22) Filed: Nov. 27, 2024

(30) Foreign Application Priority Data
Dec. 8, 2023 (EP) 23215215.7

(51) Int. Cl. G01S 7/02; G01S 7/35; G01S 13/58

(52) U.S. Cl. CPC G01S 7/0233; G01S 7/356; G01S 13/584

(57) ABSTRACT

The disclosure relates to removal of phase noise from baseband signals in an FMCW radar transceiver. Example embodiments include a method of removing phase noise from a baseband signal in an FMCW radar transceiver, the method comprising: i) receiving the baseband signal; ii) derotating the baseband signal to provide a derotated baseband signal (x₁(t)); iii) separating the derotated baseband signal (x₁(t)) into a real part (x_{1,Re}(t)) and an imaginary part (x_{1,lm}(t)); iv) performing a Hilbert transform on the real part (x_{1,Re}(t)) to provide a transformed signal (x″_{1,Re}); v) subtracting the transformed signal (x″_{1,Re}) from the imaginary part (x_{1,lm}(t)) to obtain a phase noise signal estimate (\hat{ϕ}(t)); and vi) subtracting the phase noise signal estimate (\hat{ϕ}(t)) from the baseband signal to provide a phase noise corrected signal.

### FIELD

The disclosure relates to removal of phase noise from baseband signals in an FMCW radar transceiver.

### BACKGROUND

Linear frequency modulation (LFM) chirp signals are commonly used in different types of sensors, such as radar, sonar, and ultrasound due to simple hardware implementation of the waveform generator and receiver. One advantage of linear chirps is that they enable processing large bandwidth waveforms using narrow band techniques. This can be achieved using a deramping, dechirping or stretch processing receiver, which mixes received signal echoes with the transmitted signal and estimates target ranges from the obtained narrowband beat signal. In this way, high range resolution measurements with a large dynamic range can be obtained with an ADC (analog to digital converter) having a low sampling frequency. Large dynamic range requirements are also achieved with an efficient suppression of the direct Tx-Rx leakage by an (analog) high-pass filter prior to data acquisition and by digital processing techniques such as windowing in range FFT (fast Fourier transform).

An important aspect for achieving high dynamic range performance of such systems relies on linearity of the generated chirps. For compact on-chip devices operating at high frequencies, the waveform generator (typically a PLL) may suffer from parasitic imperfections of the generated chirp, termed generically as phase noise. This noise comprises any phase error from that of an ideal linear chirp, including systematic errors and random errors caused by thermal noise, shot noise, flicker noise, and the jitter inherent to any crystal oscillator. Phase noise is an undesirable but unavoidable characteristic that adversely affects the performance of any range-Doppler radar system. Phase noise affects systems with multiple transceivers much more than systems with a single transceiver.

Whereas in a single transceiver system the receiver will largely suppress phase noise (since the same LO signal is used for TX and RX cancelling out part of the phase noise, and whitening it, i.e. decorrelating it), in the case of multiple transceivers different phase noise sources will add up at the receiver mixer. Within one transceiver, typically multiple transmitter antennas transport the same phase noise. At the RX side, each antenna will also receive similar phase noise, which will be decorrelated after the mixer in the same way for all RX paths, from one LO signal.

Uncompensated phase noise varies in time and across subsequent chips. This may result in degradation of the dynamic range in the vicinity of a target, whereby a strong echo can mask weaker targets in adjacent range cells, or in the same range cell and adjacent Doppler cells. For example, with reference to an application in automotive radar, the response of a strong object, for example a truck, can mask the response of a smaller object such as a pedestrian that is present next to it.

### SUMMARY

According to a first aspect there is provided a method of removing phase noise from a baseband signal in an FMCW radar transceiver, the method comprising:
i) receiving the baseband signal;
ii) derotating the baseband signal to provide a derotated baseband signal;
iii) separating the derotated baseband signal into a real part and an imaginary part;
iv) performing a Hilbert transform on the real part to provide a transformed signal;
v) subtracting the transformed signal from the imaginary part to obtain a phase noise signal estimate; and
vi) subtracting the phase noise signal estimate from the baseband signal to provide a phase noise corrected signal.

The method may further comprise:
vii) converting the derotated baseband signal to a frequency domain signal;
viii) subtracting magnitudes of negative frequencies of the frequency domain signal from positive frequencies of the frequency domain signal to provide an intermodulation signal; and
ix) determining signs of the intermodulation signal,
wherein step iv) comprises performing a Fourier transform of an output of the Hilbert transform, combining an output of the Fourier transform with the signs and performing an inverse Fourier transform on the combined output to provide the transformed signal.

The method may alternatively further comprise:
vii) converting the derotated baseband signal to a frequency domain signal;
viii) subtracting magnitudes of negative frequencies of the frequency domain signal from positive frequencies of the frequency domain signal to provide an intermodulation signal; and
ix) determining signs of the intermodulation signal,
wherein step iv) comprises performing a Fourier transform of the derotated baseband signal, performing the Hilbert transform in the frequency domain, combining an output of the Hilbert transform with the signs and performing an inverse Fourier transform on the combined output to provide the transformed signal.

The Hilbert transform may be performed by multiplying the Fourier transformed baseband signal by −j for frequencies greater than zero.

Step v) may comprise removing a predetermined phase noise spectrum from the phase noise signal estimate.

Steps iii) to v) may be repeated to obtain a more accurate phase noise signal estimate.

Step ii) may comprise identifying a spectral peak in the baseband signal and demodulating the baseband signal about the spectral peak.

Demodulating the baseband signal may comprise frequency shifting and normalizing the baseband signal to move the identified spectral peak to DC and with a phase of the baseband signal at +1 on the IQ plane.

According to a second aspect there is provided a phase noise correction module for an FMCW radar transceiver system, the phase noise correction module configured to:
i) receive an input baseband signal;
ii) derotate the baseband signal to provide a derotated baseband signal;
iii) separate the derotated baseband signal into a real part and an imaginary part;
iv) perform a Hilbert transform on the real part to provide a transformed signal;
v) subtract the transformed signal from the imaginary part to obtain a phase noise signal; and
vi) subtract the phase noise signal from the input baseband signal to provide an output phase noise corrected signal.

The phase noise correction module may be further configured to:
vii) convert the derotated baseband signal to a frequency domain signal;
viii) subtract magnitudes of negative frequencies of the frequency domain signal from positive frequencies of the frequency domain signal to provide an intermodulation signal; and
ix) determine signs of the intermodulation signal,
wherein the phase noise correction module is configured to provide the transformed signal by performing a Fourier transform of an output of the Hilbert transform, combining an output of the Fourier transform with the signs and performing an inverse Fourier transform on the combined output.

The phase noise correction module may be further configured to:
vii) convert the derotated baseband signal to a frequency domain signal;
viii) subtract magnitudes of negative frequencies of the frequency domain signal from positive frequencies of the frequency domain signal to provide an intermodulation signal; and
ix) determine signs of the intermodulation signal,
wherein the transformed signal is provided by performing a Fourier transform of the derotated baseband signal, performing the Hilbert transform in the frequency domain, combining an output of the Hilbert transform with the signs and performing an inverse Fourier transform on the combined output.

The Hilbert transform may be performed by multiplying the Fourier transformed baseband signal by −j for frequencies greater than zero.

According to a third aspect there is provided an FMCW radar transceiver comprising:
a signal generator configured to generate a transmit signal;
a transmit amplifier configured to amplify the transmit signal;
a transmit antenna configured to receive the amplified transmit signal from the transmit amplifier;
a receive antenna;
a receiver amplifier configured to receive a signal from the receive antenna;
a mixer configured to mix an amplified signal from the amplifier with the transmit signal from the signal generator to provide an analog baseband signal;
an analog to digital converter (ADC) configured to receive the analog baseband signal from the mixer; and
a phase noise correction module according to the second aspect configured to receive the digital baseband signal from the ADC and provide the output phase noise corrected signal.

The FMCW radar transceiver may further comprise a range Doppler module configured to receive the output phase noise corrected signal and output distance and velocity information of one or more targets in the signal from the receive antenna.

According to a fourth aspect there is provided an FMCW radar transceiver system comprising a plurality of FMCW radar transceivers according to the third aspect, further comprising a data processing unit configured to receive output distance and velocity information from each range Doppler module.

These and other aspects of the invention will be apparent from, and elucidated with reference to, the embodiments described hereinafter.

### BRIEF DESCRIPTION OF DRAWINGS

Embodiments will be described, by way of example only, with reference to the drawings, in which:

FIG. 1 is a schematic diagram of a multiple transceiver FMCW radar system with phase noise correction;

FIG. 2 is a plot of phase noise decorrelation for a single and multiple LO transceiver system observed at an IF frequency offset of 55 kHz;

FIG. 3 is a plot of phase noise decorrelation for a single and multiple LO transceivers system observed at an IF frequency offset of 1 MHZ;

FIG. 4 illustrate plots of phase noise decorrelation for bistatic (multiple LO) and mono-static (single LO) transceiver systems;

FIG. 5 is a schematic diagram of an example phase noise detector for a phase noise correction module;

FIG. 6 is a schematic diagram of an alternative example phase noise detector for a phase noise correction module;

FIG. 7 is a schematic diagram of an example phase noise estimation and correction module incorporating an iterative phase noise estimation process;

FIG. 8 illustrates and example IQ plot and corresponding real and imaginary plots for an example phase noise correction process on a received signal;

FIG. 9 is a plot of a residual noise spectrum corresponding to the example of FIG. 8;

FIG. 10 is a range spectrum plot of the example of FIGS. 8 and 9;

FIG. 11 is a phase noise time domain plot of the example of FIGS. 8 to 10.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

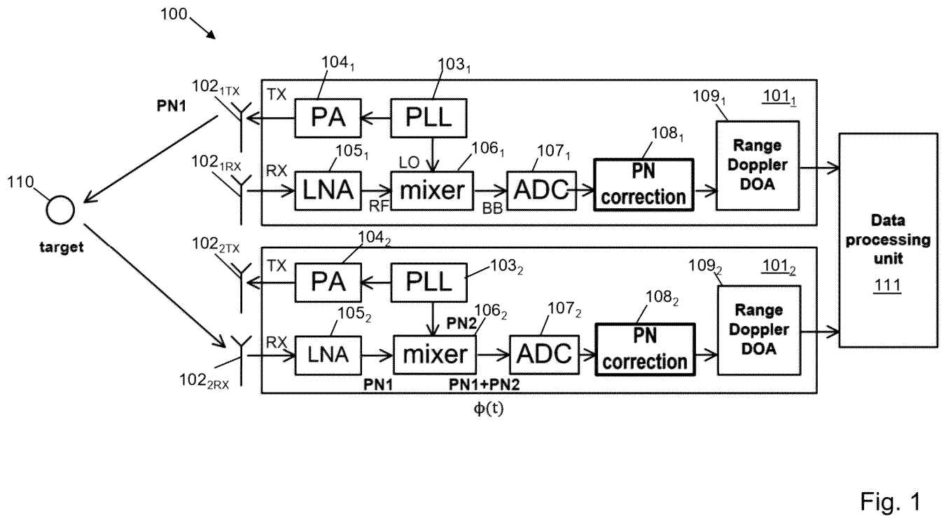

Illustrated in FIG. 1 is an example hardware architecture for a multiple transceiver radar system 100, which includes a phase noise digital correction block or module. The phase noise correction block precedes the usual signal processing and target detection of the radar system 100.

The radar system 100 comprises first and second transceivers 101₁, 101₂. Each transceiver comprises a transmit aerial 102_{1TX}, 102_{2TX} and a receive aerial 102_{2TX}, 102_{2RX}. The transmit aerial 102_{1TX}, 102_{2TX} is provided a transmit signal that is generated by a signal generator PLL 103₁, 103₂ and amplified by a transmit amplifier PA 104₁, 104₂. On the receiver side of each transceiver, a received signal from the receive aerial 102_{2TX}, 102_{2RX} is amplified by a receive amplifier LNA 105₁, 105₂ and an amplified signal provided to a mixer 106₁, 106₂. The mixer 106₁, 106₂ mixes the amplified signal with the transmit signal from the signal generator 103₁, 103₂ to generate an analog baseband signal, which is provided to an ADC 107₁, 107₂. The ADC converts the analog baseband signal to a digital baseband signal and provides this digital baseband signal to a phase noise correction module 108₁, 108₂. The phase noise correction module 108₁, 108₂ removes phase noise from the digital baseband signal and provides a phase noise corrected signal to a range doppler DOA (direction of arrival) module 109₁, 109₂, which determines the distance to and relative velocity of a target 110 identified in the baseband signal, together with a measure of the direction of arrival of the received signal, all of which can be used in combination by a data processing unit 111 to identify one or more targets in view of the transceiver system 100.

As described above, phase noise may be introduced into signals throughout the transceiver system 100, examples of which are indicated in FIG. 1. A first phase noise component PN1 is introduced in the transmit signal from the first transmit aerial 102_{1TX}. This is passed through to the received signal at the second transceiver and mixed with a second phase noise component PN2 introduced by the second signal generator 103₂. A combination of both phase noise components PN1+PN2, together termed ϕ(t), is then present in the analog baseband signal provided to the ADC 1072 in the second transceiver 101₂. A similar combination of phase noise components is provided to the ADC 107₁ in the first transceiver 101₁. The phase noise correction module 108₁, 108₂ in each transceiver is configured to separate out this phase noise and subtract it from the received digital baseband signal, as described in further detail below. The method of removing phase noise described herein aims to significantly suppress phase noise, especially (although not exclusively) in the case of multiple PLL's operating simultaneously, for example in the case of imaging or distributed radar). The method can significantly improve dynamic range in the vicinity of strong targets, where the spectral shoulders of the phase noise may be the dominant limiting factor of the sensor dynamic range.

The method may be termed blind because it operates directly on the received baseband signal and does not require a synthetic target on chip, a second measured signal or a specific antenna configuration. The method is suitable for multiple transceiver radar systems but is also suitable for a single transceiver system.

The method in essence comprises first estimating the realization of phase noise and secondly cancelling the phase noise from the received baseband signal. Since the objective is to cancel phase noise, the realization rather than its statistics must be estimated with short latency. In conceptual terms, a particular example method may be described with the following steps:
1. Operate on the baseband beat signal. If the radar receiver is real only (non-IQ), operate by analytic extension, i.e., keep only the positive range frequencies.
2. Identify the strongest spectral peak.
3. Demodulate (frequency shift and normalize) the complex baseband, to bring this strongest beat frequency to DC, and its phase locked on the IQ plane on the point 1+j0.
4. Separate the resulting signal into real and imaginary parts. The imaginary part will contain most of the phase noise, overlapped with intermodulation beat signals (at the frequency difference between the input beat frequencies and the frequency of the main peak). The real part will contain little phase noise and mainly intermodulation terms.
5. Operate a Hilbert Transform (HT) on the real part and subtract it from the imaginary part to isolate the phase noise realization for each chirp.
6. In an optional step, condition or validate the spectrum of this realization based on a-priori knowledge of phase noise spectral density, when available. In a particular example, PN may have a symmetrical spectrum which is convolved around each target. The PN spectrum may also have a regular spike-free amplitude. In most applications such amplitude will be a-priori known within a degree of uncertainty, so can be accounted for in this step.
7. Subtract the phase noise realization from the incoming signal. All the receivers in a multiple transceiver system will experience the same phase noise, so the same estimate may be used for all receiver paths of a transceiver system.

In a general aspect therefore, an example method of removing phase noise from a demodulated baseband signal involves separating the baseband signal into a real part and an imaginary part, performing a Hilbert transform on the real part, subtracting this from the imaginary part to obtain a phase noise signal estimate and then subtracting this estimate from the baseband signal to provide a phase noise corrected signal.

The following provides a more detailed description of example implementations of the method.

### Signal Model

Assume a single chirp s(t) is transmitted by a radar transceiver, defined by:

$$s ( t ) = {e}^{j 2 π ( {f}_{c} t + \frac{β {t}^{2}}{2} )} {e}^{j PN ( t )} , t ∈ [ 0 , T ] \qquad ( 1 )$$

where f_{c} denotes the carrier frequency, β=B/T is the chirp slope, T is the chirp duration and PN(t) is the undesired phase noise term, for example due to hardware imperfections. The transmitted signal s(t) impinges on targets present in the field of view of the transceiver and reflects back to the transceiver (and to other transceivers in the case of a distributed system) with a time delay τᵢ proportional to the target range. The received signal r(t) is defined as:

$$r ( i ) = {\sum }_{i} {A}_{i} {e}^{j {θ}_{i}} {e}^{j 2 {π ( {f}_{c} ( t - {τ}_{i} ) + \frac{{β ( t - {τ}_{i} )}^{2}}{2} )}_{{e}^{j P N ( t - {τ}_{i} )}}} + w ( t ) \qquad ( 2 )$$

where multiple point-like targets are assumed present in the scene with the corresponding time delays τᵢ and complex amplitudes Aᵢe^{jθ}ᵢ that include the back-scattering coefficients and propagation and hardware induced constant phase shifts with no loss of generality and w(t) denotes additive noise.

The receiver performs a deramping, dechirping or stretch processing operation, mixing the received signal with the locally generated version of the chirp (the transmitted signal in case of a single LO (local oscillator) radar transceiver or its copy generated by another LO in case of a multiple transceiver system). The resulting analog baseband signal x(t) then can be written as:

$$x ( i ) = {\sum }_{i} {A}_{i} {e}^{j ( {ω}_{i} t + {θ}_{i} )} {e}^{j {ϕ}_{i} ( t )} + w ( t ) \qquad ( 3 )$$

where ∅(t) is derived from the phase noise realization as shown below and thus is a random process with zero mean and limited bandwidth (e.g. 1 MHz). This process is filtered by a comb filter gᵢ originating from the mixing operator and target delay according to:

$${ϕ}_{i} ( t ) = ( {g}_{i} * ϕ ) ( t ) \qquad ( 4 )$$

The sign of the comb filter depends on the nature of the LO signals at the transmitter and receiver. When the same LO signal is used both at transmitter and receiver, a given phase noise realization PN(t) is used both for generating the signal and mixing it back to baseband. As a result, at the mixer output this phase noise realization will appear subtracted from its delayed replicas, and a minus sign in gᵢ will represent phase noise decorrelation at close range:

$$\begin{matrix}{g}_{i , HPF} ( t ) = δ ( t ) - δ ( t - τ ) \\ {G}_{i , HPF} ( τ , Δ f ) = \vert 2 sin ( π Δ f τ ) \vert \\ ϕ ( t ) = P N ( t )\end{matrix} \qquad ( 5 )$$

given that:

$$FT \{ δ ( t ) - δ ( t - τ ) \} = 1 - {e}^{- j ω τ} \vert G \vert = \vert 2 sin ( \frac{ω τ}{2} ) \vert$$

For independent LO signals (i.e. multiple transceivers), we need to distinguish between two approaches. A first approach is to process each bistatic individually. In this case the phase noise in each bistatic will be just another phase noise random process with 3 dB more power than each individual LO.

In fact Bi₁₂ (RX1 from TX2) will have phase noise PN₁₂=PN₁(t)−PN₂(t−τ); similarly for PN₂₁=PN₂(t)−PN₁(t−τ).

Since the two PN signals are uncorrelated, their addition will not be a filter but just an increase of 3 dB in power as mentioned. This is advantageous because it does not limit the application to a maximum range.

The second approach is to first do a conjugate product of Bi₁₂ with Bi₂₁ and then remove the phase noise from this after scaling it back a factor 2. Such an approach has immediately a 6 dB worse PN range, making it prone to wrap-around errors. Such an approach is typically done when considering co-located antennas, to get back the decorrelation gain at short distances.

In fact we can see PN(Bi₁₂*Bi₂₁*)=PN₁₂−P₂₁* =PN₁(t)—PN₂(t−τ)−(PN₂(t)−PN₁(t−ττ))=(PN₁(t)−PN₂(t))+(PN₁(t−τ)−PN₂(t−τ)) =conv(PN₁(t)−PN₂(t), (δ(t)+δ(t−τ)).

For the latter (less advantageous) conjugate product approach the resulting filtering of the phase noise is:

$$\begin{matrix}{g}_{i , LPF} ( t ) = δ ( t ) + δ ( t - τ ) \\ {G}_{i , LPF} ( τ , Δ f ) = \vert 2 cos ( π Δ f τ ) \vert \\ ϕ ( t ) = {PN}_{1} ( t ) - {PN}_{2} ( t )\end{matrix} \qquad ( 6 )$$

This latter case is more challenging because phase noise will dominate the spectrum also at close range (small τᵢ). In the case of a single LO as described in equation (5), the phase noise is significantly suppressed (e.g. in the order of 30 dB), for close by targets, by the decorrelation function implicit in that comb filter. This 30 dB suppression is true for R<=14 m. In fact G_{iHPF} (τ, Δf)=2|sin(πΔfτ)|; τ=2R/c: G_{i,HPF}(R, Δf)˜4π Δf R/c. Δf=55e3 corner value of PN spectrum where PN starts decaying at more than 20 dB/decade, since decorrelation HPF is +20 dB decade, this is also the frequency offset of the peak after decorrelation: 20*log10 (4*pi*55e3*14/3e8)=−30 dB.

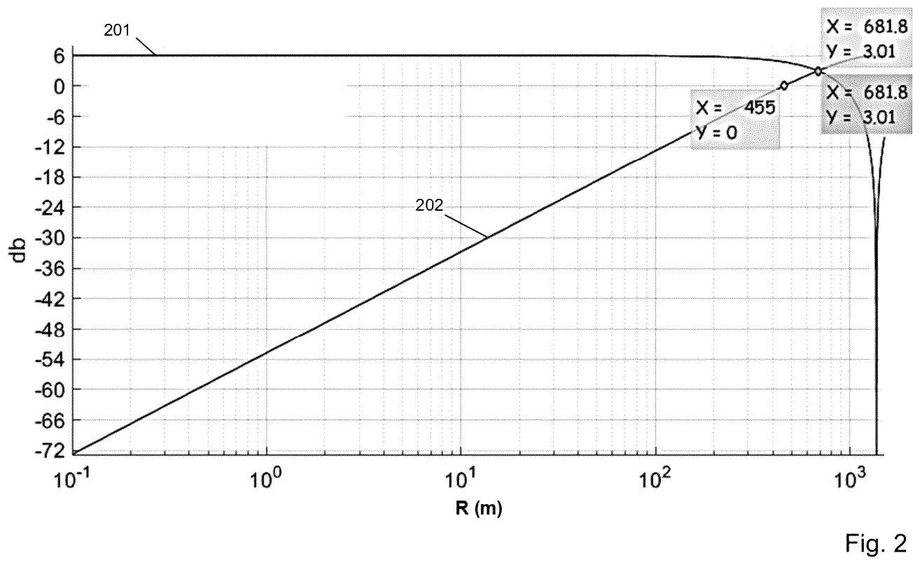

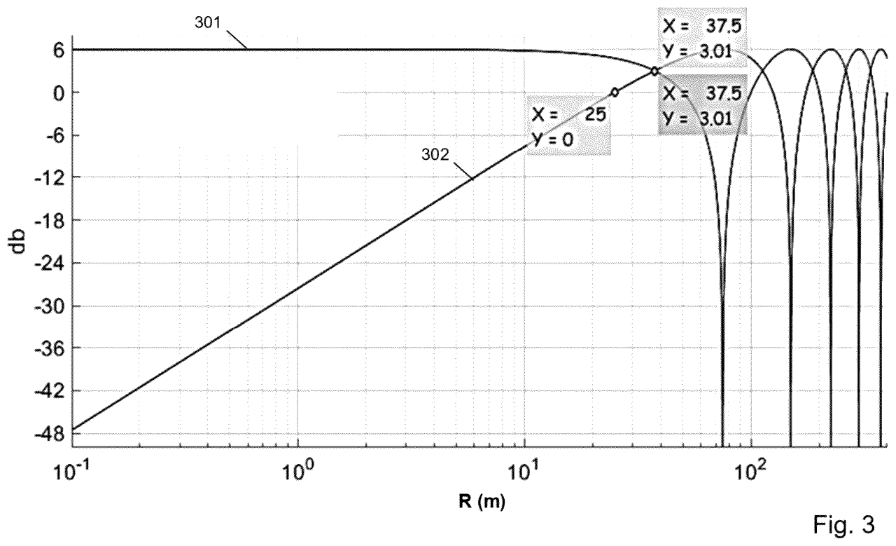

FIGS. 2 and 3 illustrate phase noise decorrelation for a single LO 201, 301 transceiver (according to equation 5) and a multiple LO transceiver system 202, 302 (according to equation 6) at two frequency offsets, with a 55 kHz offset in FIG. 2 and a 1 MHz offset in FIG. 3. For a single LO, the 1 MHz offset measured phase noise is on par with the transmitter phase noise (PLL specification) at R=25 m, and 3 dB higher at R-=37.5 m. For a multiple LO, the receiver phase noise at 1 MHz offset will be reduced by 3 dB at R=37.5 m (this is a limitation of the above-mentioned conjugate product approach). For far away targets, thermal noise is dominant over phase noise and it is often not a concern.

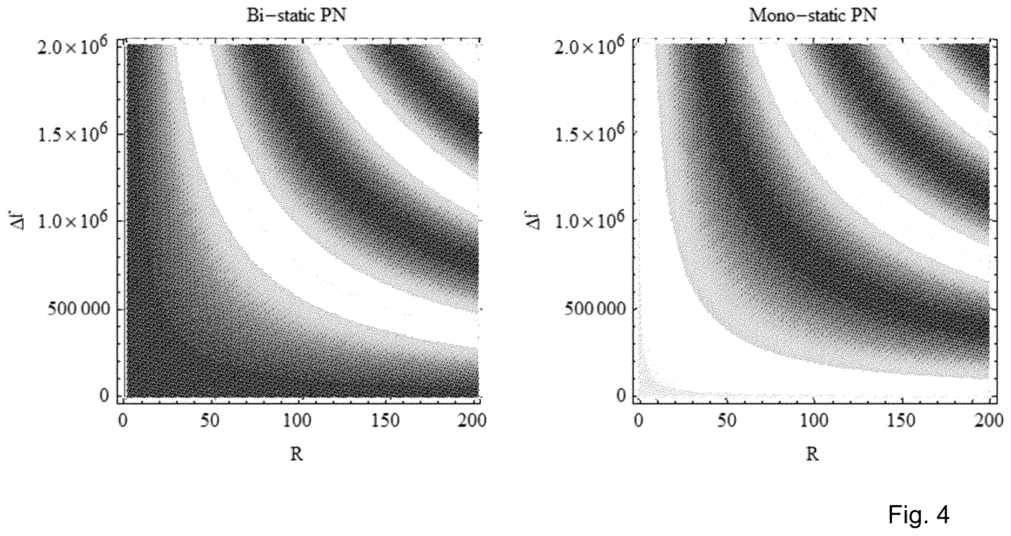

FIG. 4 illustrates phase noise decorrelation for bistatic (i.e. multiple LO transceiver systems according to equation 6) and mono-static (single LO transceivers according to equation 5), in which darker regions indicate higher phase noise.

For the case of multiple LO signals at the transmitter and receiver, it is convenient to simplify the signal model, upon realizing that within a certain close range the LPF (low pass filter) function in equation 6 above can be well approximated by an all-pass. For independent LO signals, each ϕᵢ(t) is a LPF version of ϕ(t) according to:

$${G}_{i , LPF} ( {f}_{i} , Δ f ) = 2 \vert cos ( 2 π \frac{Δ f {f}_{i}}{2 β} ) \vert \qquad ( 7 )$$

where fᵢ is the beat frequency of target i and Δf is the one-sided phase noise bandwidth around that target. The frequency interval where the LPF effect can be considered negligible is Δf_{3dB}, i.e. the filter's 3 dB cut off frequency.

$$\begin{matrix}\frac{Δ {f}_{3 d B} {f}_{i}}{2 β} 2 π = \frac{π}{4} \\ Δ {f}_{3 d B} = \frac{β}{4 {f}_{i}} = \frac{c}{8 {R}_{i}}\end{matrix} \qquad ( 8 )$$

Typical phase noise spectra with current radar hardware tend to have a flat top spectrum with a bandwidth of about 55 kHz one sided (PLL bandwidth), and a 1/f^{α} power slope from there on, with α≥2. For this reason, a total one-sided bandwidth of Δf_{3dB}=1 MHz is sufficient to capture most of the PN power (e.g. for α=2.4 the corner value at 1 MHz compared to the center value is lower by 24*log 10 (1e6/55e3)=30 dB. There is a maximum range below which the LPF in the equation 7 filter cut off will not cut into this 1 MHz band, in which region the LPF can be neglected. This range can be defined as:

$${R}_{ma x , AllPass} = \frac{c}{8 e 6} = 37.5 m \qquad ( 9 )$$

If we restrict the phase noise estimation for the multiple LO case to ranges inferior to this limit, the phase noise can be factored out by rewriting equation 3 as follows:

$$x ( t ) = {e}^{j ϕ ( t )} {\sum }_{i} {A}_{i} {e}^{j ( {ω}_{i} t + {θ}_{i} )} + w ( t ) \qquad ( 10 )$$

The power spectrum Φₓₓ(f) of the phase noise in radians²/Hz can be assumed to be approximately known. Φₓₓ(f) can be considered unfiltered for the band and range of interest (1 MHz, 37.5 m).

Phase Noise Estimation

Among all reflections At in equation 10, the largest one, A₀, is selected and its corresponding frequency and phase are given by ω₀, θ₀. There could be multiple targets within one range frequency bin, in which case A₀ will represent the combined strength of these targets, i.e. A₀ is the amplitude of the range DFT at its peak. The frequency ω₀, and the amplitude A₀ will need to be estimated accurately, which in practice means not just on the FFT grid but with a sub-grid accuracy using for example an interpolation method.

Using these estimated values (ω₀, A₀, θ₀), an auxiliary signal

$${\tilde{x}}_{0} = \frac{1}{{A}_{0}} {e}^{- j ( {ω}_{0} t + {θ}_{0} )}$$

can be generated, which is used to de-rotate the full IF signal into a signal x₁, such that the main target will appear at DC in the frequency domain and around the point (1+j0) in the IQ plane, resulting in the baseband signal x₁(t) then being expressed as:

$${x}_{1} ( t ) = \frac{1}{{A}_{0}} {e}^{- j ( {ω}_{0} t + {θ}_{0} )} x ( t ) \approx ( {e}^{j ϕ ( t )} + {\sum }_{i \neq 0} {A}_{i} {e}^{j ( ( {ω}_{i} - {ω}_{0} ) t + {θ}_{i} - {θ}_{0} + ϕ ( t ) )} ) \qquad ( 11 )$$

In the following, the term x is used for the input signal with phase noise present, x₁ for the de-rotated signal, and x₂ for the denoised signal.

Splitting the de-rotated signal x₁(t) from equation 11 into its real and imaginary parts provides:

$$\begin{matrix}{x}_{1 , R e} ( t ) = cos ( ϕ ( t ) ) + {\sum }_{i \neq 0} {A}_{i} cos ( ( {ω}_{i} - {ω}_{0} ) t + {θ}_{i} - {θ}_{0} + ϕ ( t ) ) \\ {x}_{1 , I m} ( t ) = sin ( ϕ ( t ) ) + {\sum }_{i \neq 0} {A}_{i} sin ( ( {ω}_{i} - {ω}_{0} ) t + {θ}_{i} - {θ}_{0} + ϕ ( t ) )\end{matrix} \qquad ( 12 )$$

$$\begin{matrix}{x}_{1 , R e} ( t ) \approx 1 + {\sum }_{i \neq 0} {A}_{i} cos ( Δ {ω}_{i} t + Δ {θ}_{i} + ϕ ( t ) ) \\ {x}_{1 , I m} ( t ) \approx ( β ( t ) + {\sum }_{i \neq 0} {A}_{i} sin ( Δ {ω}_{i} t + Δ {θ}_{i} + ϕ ( t ) )\end{matrix} \qquad ( 13 )$$

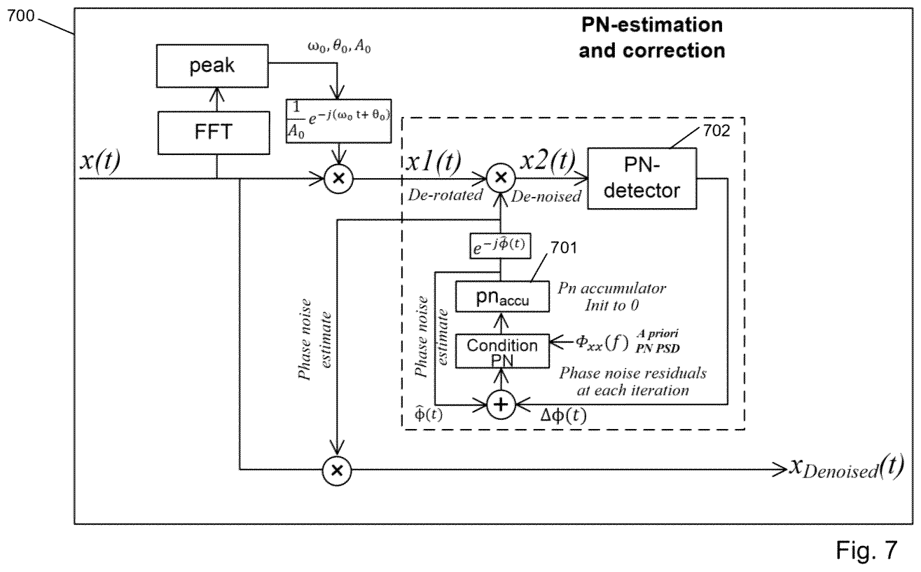

The approximate functions in equation 13 depend on cos (ϕ) being equal to 1 when the phase noise is close to zero. In practice, an iterative approach, described below in relation to the example of FIG. 7, may be used so that residuals will converge to zero as the phase noise is removed in each iteration. In the real part of equation 10, the term cos (ϕ(t))˜1 (the RMS value of the phase noise is assumed about 10 degrees here; the method can be unstable for large phase noise about 30 degrees RMS), therefore there is little information about phase noise in the real part. The SNR is therefore much better in x_{1,Re}(t) than in x_{1,Im}(t) due to suppression of phase noise on this branch.

In the imaginary part, we observe that the signal of interest ϕ is overlapped with undesired Inter-Modulation (IM) tones Δωᵢ=(ωᵢ−ω₀). These IM tones can be removed to extract phase noise from the signal as defined by equation 13.

An approach to removing the IM tones is to extract them from the real part and then subtract them from the imaginary part. For this to be mathematically possible, all the terms in real and imaginary parts must be different in absolute offset frequency value. If two identical and opposite Δωᵢ terms exist, depending on Δθᵢ some terms might disappear from the real and not from the imaginary part or vice versa. This is commented on further below.

First, we recall a property of the Hilbert Transform:

$$\begin{matrix}( cos ( ω t + θ ) ) = sgn ( ω ) sin ( ω t + θ ) \\ ( sin ( ω t + θ ) ) = - sgn ( ω ) cos ( ω t + θ )\end{matrix} \qquad ( 14 )$$

Applying the Hilbert Transform (HT) to the real part x_{1,Re}(t) of equation 13, the transformed real part x′_{1,Re}(t) can be expressed as:

$$\begin{matrix}{x}_{1 , R e}^{′} ( t ) = ( {x}_{1 , R e} ( t ) ) \approx {\sum }_{i \neq 0} {A}_{i} {s}_{i} sin ( Δ {ω}_{i} t + Δ {θ}_{i} + ϕ ( t ) ) \\ {s}_{i} = sgn ( Δ {ω}_{i} )\end{matrix} \qquad ( 15 )$$

The signal x′_{1,Re}(t) in equation 15 can be compared against the imaginary part x_{1,lm}(t) in equation 13. Except for the as-yet unknown signs sᵢ, x′_{1,Re}, this contains all the undesired IM terms which we need to subtract from x_{1,Im}(t) to obtain an estimate of the phase noise ∅.

$$\begin{matrix}{x}_{1 , R e}^{″} ( t ) = {\sum }_{i \neq 0} {A}_{i} \hat{{s}_{l}} {s}_{i} sin ( Δ {ω}_{i} t + Δ {θ}_{i} + ϕ ( t ) ) \\ ϕ ( t ) \approx {x}_{1 , I m} ( t ) - x {1}_{R e}^{″}\end{matrix} \qquad ( 16 )$$

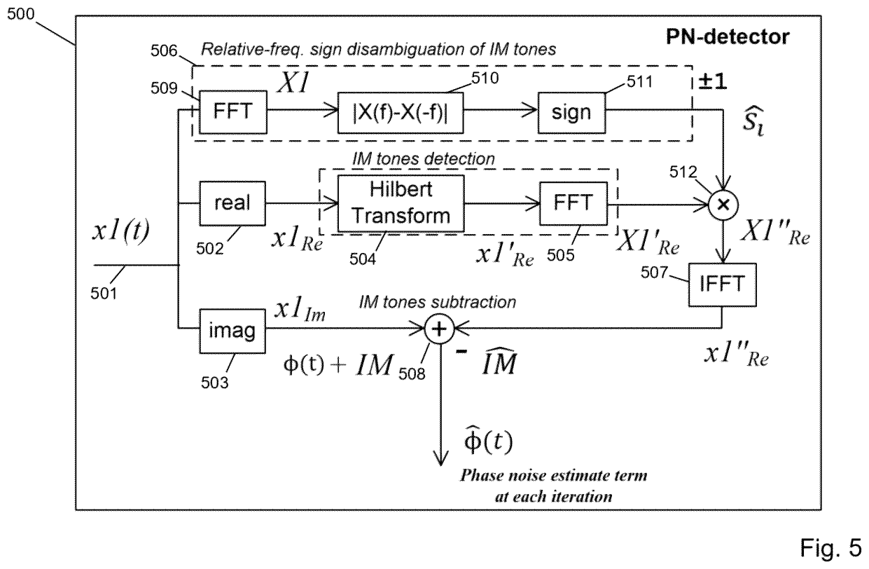

Detecting the signs sᵢ is possible if the IM products are not too far drowned into phase noise. We will extract this sign from the full complex signal x₁(t), comparing its positive vs negative frequencies. In this equation and the block diagrams of FIGS. 5, 6 and 7, the discrete counterpart n of continuous time t is used, i.e. t=n/fₛ, and k=f/df=f*Ta, where fₛ is the ADC sampling frequency and Ta the acquisition time within one chirp:

$$\begin{matrix}{X}_{1} ( k ) = F F T ( {x}_{1} ( n ) ) \\ \hat{{s}_{l}} ( k ) = sgn ( \vert {X}_{1} ( k ) \vert - \vert {X}_{1} ( - k ) \vert ) \\ {X}_{1 , R e}^{′} ( k ) = F FT ( {x}_{1 , R e}^{′} ( n ) ) \\ {x}_{1 , R e}^{″} ( n ) = IFFT ( {X}_{1 , R e}^{′} * \hat{{s}_{l}} ) \\ \hat{ϕ} ( n ) \approx {x}_{1 , I m} ( n ) - {x}_{1 , R e}^{′} ( n )\end{matrix} \qquad ( 17 )$$

The processing flow of the phase noise detector 500, which reflects the equations above, is illustrated in FIG. 5. The phase noise detector 500 is part of the phase noise correction module 109₁, 109₂ of the transceiver system 100 illustrated in FIG. 1, including all components except for derotation of the baseband signal and subtraction of the estimated phase noise from the baseband signal.

The derotated baseband signal x₁(t) is received at an input 501 of the phase noise detector 500. First and second branches 502, 503 separate the baseband signal x₁(t) into a real part x_{1,Re}(t) and an imaginary part x1,Im (t). A Hilbert transform 504 is then performed on the real part x_{1,Re}(t) to produce an intermediate transformed signal x′_{1,Re}. This is further processed by being transformed into the frequency domain with an FFT module 505 and combined at a combining node 512 with an output [symbol] (k) of a third branch 506 (described below) before being transformed back into the time domain by an inverse FFT module 507 to provide a transformed signal x″_{1,Re}. The transformed signal x″_{1,Re} and the imaginary part x_{1,Im}(t) are provided to a subtraction module 508, which subtracts the transformed signal x″_{1,Re} from the imaginary part x_{1,Im}(t) to obtain a phase noise signal estimate \hat{ϕ}(n). The phase noise signal estimate \hat{ϕ}(n) can then be subtracted from the baseband signal x₁(t) to provide a phase noise corrected signal x₂(t). The process may then repeat in an iterative way to further reduce the phase noise.

The third branch 506 extracts the signs [symbol] (k) from the baseband signal x₁(t) in the frequency domain for disambiguation of IM tones. The third branch 506 comprises an FFT module 509, which converts the baseband signal x₁(t) into a frequency domain signal X₁(k). A normalising module 510 subtracts the negative frequencies from the positive frequencies to provide an intermodulation signal. After such subtraction the amplitude spectrum of phase noise which is symmetric around f=0 will have vanished, and only IM tones will remain. A sign module 511 then outputs the signs [symbol] (k) of the intermodulation signal to the combining node 512 to be combined with the intermediate transformed signal x′_{1,Re}.

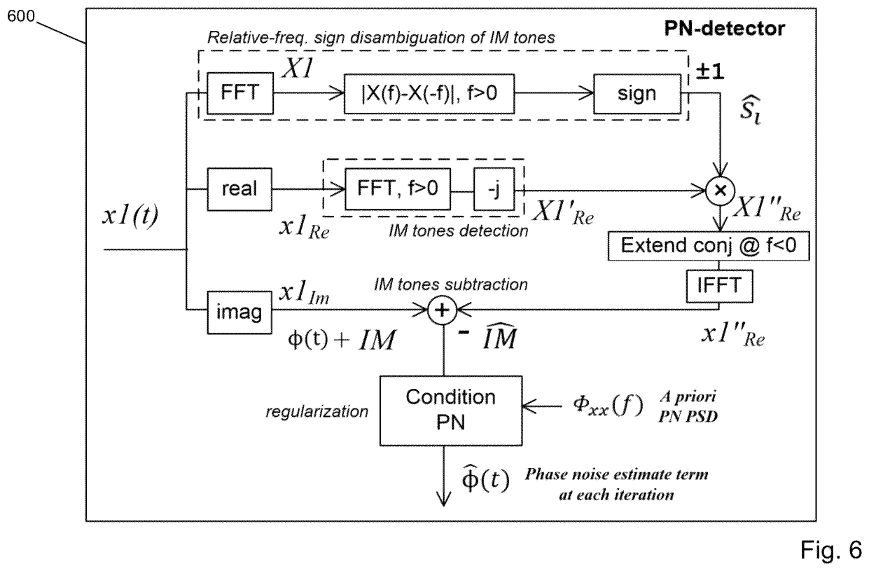

An alternative example PN-detector 600, which reflects the equations above, is illustrated in FIG. 6. The PN-detector 600 differs from the detector 500 in FIG. 5 by swapping the linear operators Hilbert Transform (HT) and FFT, and by exploiting the conjugate symmetry of real signals spectra, thereby computing the IM tones only using half band (f>0). The HT in the frequency domain corresponds to the product with −j·sgn(f), which is then a multiplication by −j at f>0. The DC term in the real part x_{1,Re}(t) is omitted by starting the FFT on the real part from f>0; −j·sgn (f) would zero this frequency.

The block denoted “Condition PN” in FIG. 6 is utilized to limit the leakage of undesired intermodulation products. This block utilizes a priori, i.e. predetermined, knowledge of the phase noise spectrum (PLL characteristic) to remove intermodulation products and improve the robustness of the solution in presence of multiple targets in the vicinity of each other. This is particularly needed for the case of exactly symmetric targets around the selected FFT peak, with offset frequencies ±Δω. In this case some of the terms in equation 13 may disappear from either the real or the imaginary parts. For the sake of illustration this situation is depicted in equation 18 below.

$$\begin{matrix}{x}_{1 , R e} ( t ) \approx 1 + {A}_{1} cos ( Δ {θ}_{1} + Δ ω t ) + {A}_{2} cos ( Δ {θ}_{2} - Δω t ) \\ {x}_{1 , I m} ( t ) \approx ϕ ( t ) + {A}_{1} sin ( Δ {θ}_{1} + Δω t ) + {A}_{2} sin ( Δ {θ}_{2} - Δω t ) \\ {x}_{1 , R e}^{′} ( t ) \approx {A}_{1} sin ( Δ {θ}_{1} + Δω t ) - {A}_{2} sin ( Δ {θ}_{2} - Δω t ) \\ {x}_{1 , I m} ( t ) - {x}_{1 , R e}^{′} ( t ) = ϕ ( t ) + 2 {A}_{2} sin ( Δ {θ}_{2} - Δω t )\end{matrix} \qquad ( 18 )$$

It can be seen from this that the HT of the real part, x′_{1,Re}(t), will now not be able to remove the unwanted tone, but instead will plug it back in at the opposite side of the main target. Such IM tones cannot be allowed to pass, or they will either offset existing targets, or create new targets.

Phase Noise Estimation and Compensation Loop

FIG. 7 illustrates an example phase noise correction module 700 implementing an iterative scheme incorporating the PN detector of either FIG. 5 or FIG. 6, in which an estimate \hat{∅}(t) of ∅(t) is stored into an accumulator register 701, which is initialized to 0, and further converted to its phasor representation e^{-j\hat{∅}(t)} to demodulate the phase noise away from the de-rotated signal x₁(t), into the de-noised signal x₂(t).

At the first iteration x₂(t) will fully contain the input phase noise. The PN detector 702, as described above, will produce a first phase noise estimate. This is then conditioned by prior knowledge about phase noise spectral properties and added to the accumulator 701 for the next iteration. At the second iteration the signal x₂(t) will be cleaner and the PN detector 702 will produce a residual phase noise estimate Δ∅(t). At each iteration this residual will be smaller, and the accumulator output \hat{∅} will come closer to the true phase noise ∅. The power of the residual and its time evolution can be used to stop the loop or signal a malfunction. In situations with a high SNR, the DC value of x₂(t) will keep increasing as long as more phase noise is being removed. This can also be used to decide whether estimation is completed and/or successful.

Simulations

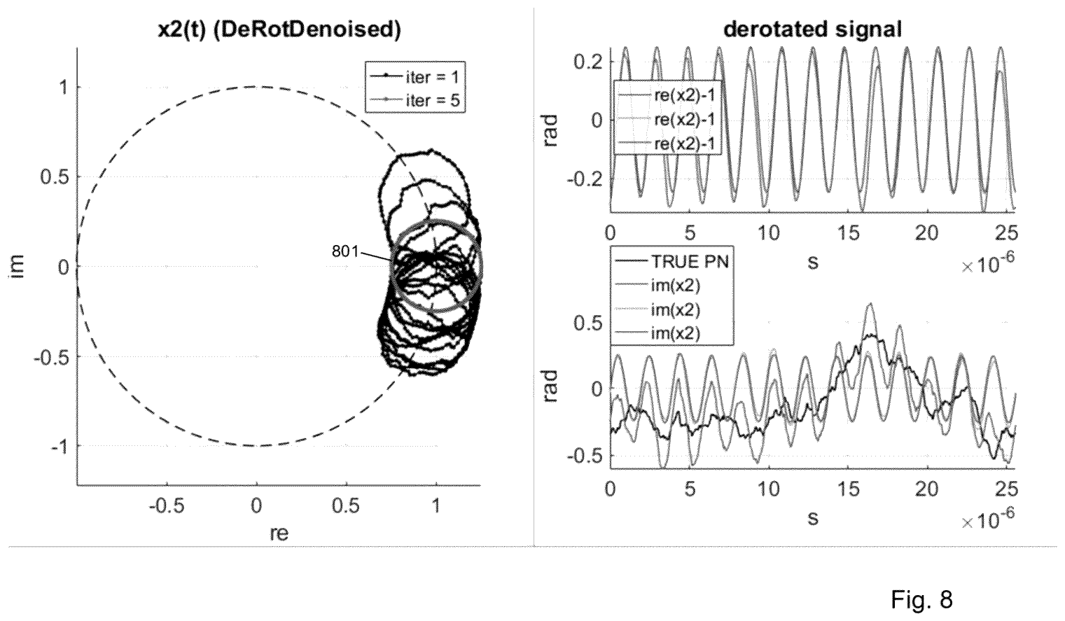

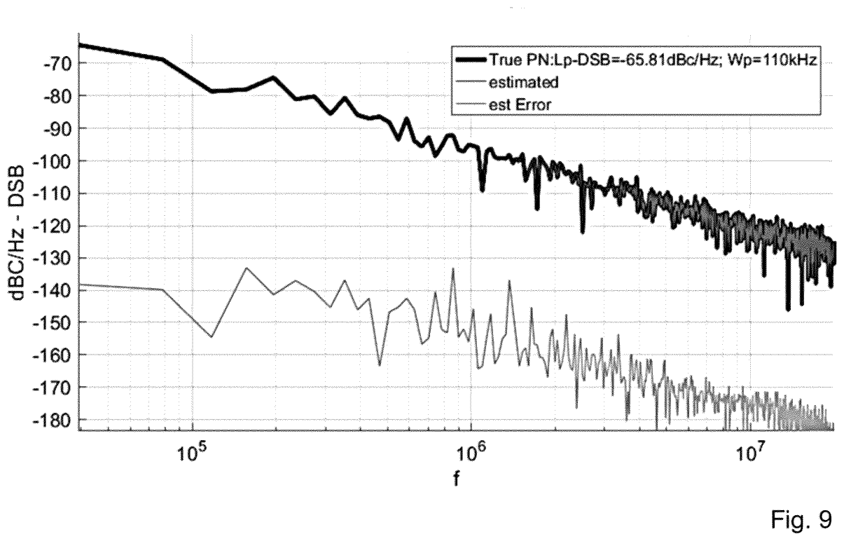

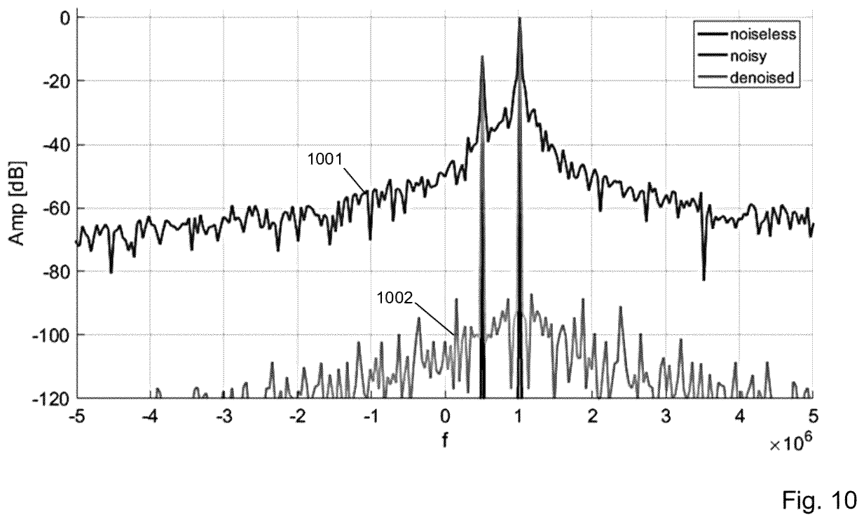

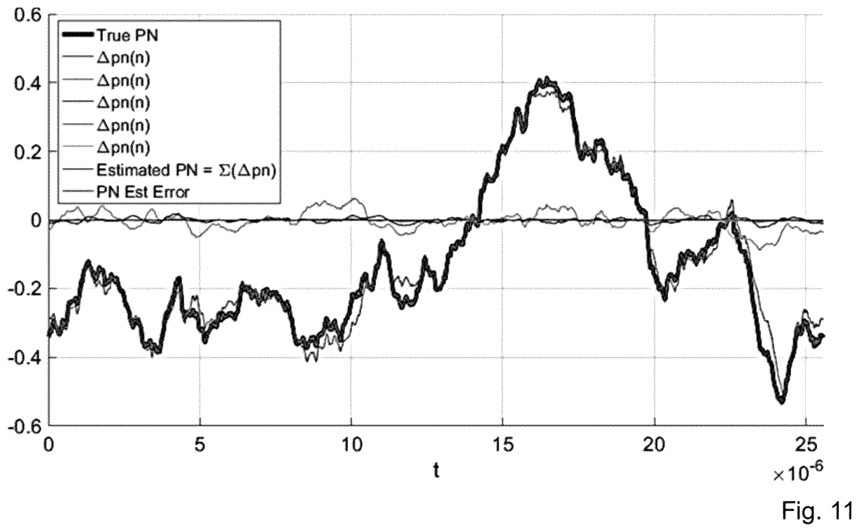

Consider the following example with radar parameters of acquisition time T_{acq}=25.6 μs and fs=40 MHz. FIG. 8 presents an IQ plane of the de-rotated signal x₁(t), along with plots of the real and imaginary parts. The curves show the result of successive iterations, resulting in a final estimate (after five iterations in this case) that converges to a circle 801 in the IQ plane, corresponding to a plot in the real part that indicates a secondary target, with other random components cleaned up. The left plot represents the x₂(t) signal, which shows a first tone at 0 Hz (corresponding to a main target) and second at an offset (corresponding to a secondary target), with phase noise removed after in this case five iterations. The right plots represent the real and imaginary values as a function of time. The residual phase noise spectrum, illustrated in FIG. 9, demonstrates about a 70 dB improvement. This similarly maps to the obtained range spectrum illustrated in FIG. 10, in which the noisy spectrum 1001 is transformed to a denoised spectrum 1002, demonstrating about 60 dB of phase noise rejection and therefore a dynamic range gain with the utilization of the proposed algorithm. This result is confirmed with the time realization of the estimated phase noise illustrated in FIG. 11 that accurately follows the simulated realization. Similar results are obtained with multiple targets present. For example, with four targets present in the scene the algorithm still converges in only a few iterations and demonstrates significant improvement in the dynamic range of the range profile.

The method and transceiver system described herein enables a noisy signal from a transceiver to be cleaned from phase noise in postprocessing, i.e. in the digital domain after reception and down-conversion, without relying on any other signal and without imposing constraints on the antenna array and/or on the RF radar hardware. The proposed solution is carried out before range Doppler processing and can be carried out chirp by chirp. This can be particularly useful because it does not require storing the radar frame.

From reading the present disclosure, other variations and modifications will be apparent to the skilled person. Such variations and modifications may involve equivalent and other features which are already known in the art of radar transceivers, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1-15. (canceled)

16. A method of removing phase noise from a baseband signal in an FMCW radar transceiver, the method comprising:
i) receiving the baseband signal;
ii) derotating the baseband signal to provide a derotated baseband signal;
iii) separating the derotated baseband signal into a real part and an imaginary part;
iv) performing a Hilbert transform on the real part to provide a transformed signal;
v) subtracting the transformed signal from the imaginary part to obtain a phase noise signal estimate; and
vi) subtracting the phase noise signal estimate from the baseband signal to provide a phase noise corrected signal.

17. The method of claim 16, comprising:
vii) converting the derotated baseband signal to a frequency domain signal;
viii) subtracting magnitudes of negative frequencies of the frequency domain signal from positive frequencies of the frequency domain signal to provide an intermodulation signal; and
ix) determining signs of the intermodulation signal,
wherein step iv) comprises performing a Fourier transform of an output of the Hilbert transform, combining an output of the Fourier transform with the signs and performing an inverse Fourier transform on the combined output to provide the transformed signal.

18. The method of claim 16, comprising:
vii) converting the derotated baseband signal to a frequency domain signal;
viii) subtracting magnitudes of negative frequencies of the frequency domain signal from positive frequencies of the frequency domain signal to provide an intermodulation signal; and
ix) determining signs of the intermodulation signal,
wherein step iv) comprises performing a Fourier transform of the derotated baseband signal, performing the Hilbert transform in the frequency domain, combining an output of the Hilbert transform with the signs and performing an inverse Fourier transform on the combined output to provide the transformed signal.

19. The method of claim 18, wherein the Hilbert transform is performed by multiplying the Fourier transformed baseband signal by −j for frequencies greater than zero.

20. The method of claim 16, wherein step v) comprises removing a predetermined phase noise spectrum from the phase noise signal estimate.

21. The method of claim 20, wherein steps iii) to v) are repeated to obtain a more accurate phase noise signal estimate.

22. The method of claim 16, wherein step ii) comprises identifying a spectral peak in the baseband signal and demodulating the baseband signal about the spectral peak.

23. The method of claim 22, wherein demodulating the baseband signal comprises frequency shifting and normalizing the baseband signal to move the identified spectral peak to DC and with a phase of the baseband signal at +1 on the IQ plane.

24. A phase noise correction module for an FMCW radar transceiver system, the phase noise correction module configured to:
i) receive an input baseband signal;
ii) derotate the baseband signal to provide a derotated baseband signal;
iii) separate the derotated baseband signal into a real part and an imaginary part;
iv) perform a Hilbert transform on the real part to provide a transformed signal;
v) subtract the transformed signal from the imaginary part to obtain a phase noise signal; and
vi) subtract the phase noise signal from the input baseband signal to provide an output phase noise corrected signal.

25. The phase noise correction module of claim 24, further configured to:
vii) convert the derotated baseband signal to a frequency domain signal;
viii) subtract magnitudes of negative frequencies of the frequency domain signal from positive frequencies of the frequency domain signal to provide an intermodulation signal; and
ix) determine signs of the intermodulation signal,
wherein the phase noise correction module is configured to provide the transformed signal by performing a Fourier transform of an output of the Hilbert transform, combining an output of the Fourier transform with the signs and performing an inverse Fourier transform on the combined output.

26. The phase noise correction module of claim 24, further configured to:
vii) convert the derotated baseband signal to a frequency domain signal;
viii) subtract magnitudes of negative frequencies of the frequency domain signal from positive frequencies of the frequency domain signal to provide an intermodulation signal; and
ix) determine signs of the intermodulation signal,
wherein the transformed signal is provided by performing a Fourier transform of the derotated baseband signal, performing the Hilbert transform in the frequency domain, combining an output of the Hilbert transform with the signs and performing an inverse Fourier transform on the combined output.

27. The phase noise correction module of claim 26, wherein the Hilbert transform is performed by multiplying the Fourier transformed baseband signal by −j for frequencies greater than zero.

28. An FMCW radar transceiver comprising:
a signal generator configured to generate a transmit signal;
a transmit amplifier configured to amplify the transmit signal;
a transmit antenna configured to receive the amplified transmit signal from the transmit amplifier;
a receive antenna;
a receiver amplifier configured to receive a signal from the receive antenna;
a mixer configured to mix an amplified signal from the amplifier with the transmit signal from the signal generator to provide an analog baseband signal;
an analog to digital converter (ADC) configured to receive the analog baseband signal from the mixer; and
a phase noise correction module configured to:
i) receive a digital input baseband signal from the ADC;
ii) derotate the baseband signal to provide a derotated baseband signal;
iii) separate the derotated baseband signal into a real part and an imaginary part;
iv) perform a Hilbert transform on the real part to provide a transformed signal;
v) subtract the transformed signal from the imaginary part to obtain a phase noise signal; and
vi) subtract the phase noise signal from the input baseband signal to provide an output phase noise corrected signal.

29. The FMCW radar transceiver of claim 28, further comprising a range Doppler module configured to receive the output phase noise corrected signal and output distance and velocity information of one or more targets in the signal from the receive antenna.

30. An FMCW radar transceiver system comprising a plurality of FMCW radar transceivers according to claim 29, further comprising a data processing unit configured to receive output distance and velocity information from each range Doppler module.

31. The FMCW radar transceiver of claim 28, wherein the phase noise correction module is further configured to:
vii) convert the derotated baseband signal to a frequency domain signal;
viii) subtract magnitudes of negative frequencies of the frequency domain signal from positive frequencies of the frequency domain signal to provide an intermodulation signal; and
ix) determine signs of the intermodulation signal,
wherein the phase noise correction module is configured to provide the transformed signal by performing a Fourier transform of an output of the Hilbert transform, combining an output of the Fourier transform with the signs and performing an inverse Fourier transform on the combined output.

32. The FMCW radar transceiver of claim 28, wherein the phase noise correction module is further configured to:
vii) convert the derotated baseband signal to a frequency domain signal;
viii) subtract magnitudes of negative frequencies of the frequency domain signal from positive frequencies of the frequency domain signal to provide an intermodulation signal; and
ix) determine signs of the intermodulation signal,
wherein the transformed signal is provided by performing a Fourier transform of the derotated baseband signal, performing the Hilbert transform in the frequency domain, combining an output of the Hilbert transform with the signs and performing an inverse Fourier transform on the combined output.

33. The FMCW radar transceiver of claim 32, wherein the Hilbert transform is performed by multiplying the Fourier transformed baseband signal by −j for frequencies greater than zero.

34. The FMCW radar transceiver of claim 28, wherein step ii) comprises identifying a spectral peak in the baseband signal and demodulating the baseband signal about the spectral peak.

35. The FMCW radar transceiver of claim 34, wherein demodulating the baseband signal comprises frequency shifting and normalizing the baseband signal to move the identified spectral peak to DC and with a phase of the baseband signal at +1 on the IQ plane.
